(19) United States
(12) Patent Application Publication
(10) Pub. No.: US 2006/0134472 A1
(43) Pub. Date: Jun. 22, 2006

(54) Summer and winter mode operation of fuel cell stacks

(76) Inventors: Peter J. Bach, Vancouver (CA); Craig R. Louie, West Vancouver (CA); Caroline J. E. Andrewes, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/019,126

(22) Filed: Dec. 21, 2004

(51) Int. Cl. H01M 8/04

(52) U.S. Cl. 429/13; 429/38; 429/24

(57) ABSTRACT

A fuel cell subject to intermittent use may be operated in two distinct modes, a “summer” or a “winter” mode, depending on whether the cell is expected to be stored at below freezing temperatures or not. At steady state in summer mode, much of the cell interior may be fully saturated with water and thus may contain liquid water. While such conditions may be most desirable for performance reasons during operation, the presence of liquid water however may be detrimental when storing at below freezing temperatures. At steady state in winter mode, the cell interior is essentially sub-saturated throughout and liquid water is not present to form ice during storage. Winter mode operation allows for improved performance during startup, especially in automotive solid polymer electrolyte fuel cell stacks.

### BACKGROUND OF THE INVENTION

1. Field of the Invention

The invention relates to methods for obtaining improved startup performance from fuel cells following shutdown and subsequent freezing. In particular, it relates to methods for improving startup performance in solid polymer electrolyte fuel cell stacks.

2. Description of the Related Art

Fuel cell systems are presently being developed for use as power supplies in a wide variety of applications. In particular, much effort is being spent on developing fuel cell engines for automotive use because fuel cells offer higher efficiencies and reduced pollution compared to internal combustion engines.

Fuel cells convert fuel and oxidant reactants to generate electric power and reaction products. They generally employ an electrolyte disposed between cathode and anode electrodes. A catalyst typically induces the desired electrochemical reactions at the electrodes. The presently preferred fuel cell type for portable and motive applications is the solid polymer electrolyte (SPE) fuel cell which comprises a solid polymer electrolyte and operates at relatively low temperatures.

SPE fuel cells employ a membrane electrode assembly (MEA) which comprises the solid polymer electrolyte or ion-exchange membrane disposed between the cathode and anode. Each electrode contains a catalyst layer, comprising an appropriate catalyst, located next to the solid polymer electrolyte. The catalyst is typically a precious metal composition (e.g., platinum metal black or an alloy thereof) and may be provided on a suitable support (e.g., fine platinum particles supported on a carbon black support). The catalyst layers may contain ionomer similar to that used for the solid polymer membrane electrolyte (e.g., Nafion®). The electrodes may also contain a porous, electrically conductive substrate that may be employed for purposes of mechanical support, electrical conduction, and/or reactant distribution, thus serving as a fluid diffusion layer. Flow field plates for directing the reactants across one surface of each electrode or electrode substrate, are disposed on each side of the MEA. In operation, the output voltage of an individual fuel cell under load is generally below one volt. Therefore, in order to provide greater output voltage, numerous cells are usually stacked together and are connected in series to create a higher voltage fuel cell series stack.

During normal operation of a SPE fuel cell, fuel is electrochemically oxidized at the anode catalyst, typically resulting in the generation of protons, electrons, and possibly other species depending on the fuel employed. The electrons travel through an external circuit providing useable power and then electrochemically react with protons and oxidant at the cathode catalyst to generate water reaction product. The protons are conducted from the reaction sites at which they are generated, through the electrolyte, to react with the oxidant and electrons at the cathode catalyst.

In some fuel cell applications, the demand for power can essentially be continuous and thus the stack may rarely be shutdown (such as for maintenance). However, in many applications (e.g., as an automobile engine), a fuel cell stack may frequently be stopped and restarted with significant storage periods in between. Such cyclic use can pose certain problems in SPE fuel cell stacks, particularly when freezing conditions may be encountered during storage.

Because the ionic conductivity in typical SPE fuel cell electrolytes increases with hydration level, the fuel cell stacks are usually operated in such a way that the membrane electrolyte is as fully saturated with water as is possible without “flooding” the cells with liquid water (“flooding” refers to a situation where liquid water accumulates and hinders the flow and/or access of gases in the fuel cell). In this way, maximum power output can be provided during normal operation. However, while this may be beneficial during normal operation, a significant amount of liquid water may then exist or condense in the stack when it is shutdown and stored. This water will then freeze if stored at below freezing temperatures. The presence of ice inside can result in permanent damage to the stack. Even if such damage is avoided, the presence of ice can still hinder subsequent startup.

Various methods have thus been employed to reduce the water content inside before shutting down the stack for storage. (In these methods, not too much water should be removed or the conductivity of the membrane electrolyte can be substantially reduced, with resulting poor power capability from the stack when restarting.) For instance, the channels in the stack can be purged with dry gases (e.g., as disclosed in U.S. Pat. No. 6,479,177), the stack can be vacuum dried (e.g., as disclosed in U.S. Pat. No. 6,358,637) and/or the stack can be operated in a drying mode just before shut down (e.g., as disclosed in US2003/0186093). However, such techniques can require a significant time period to implement and may also require additional equipment in the system. It is not always possible in practice though to predict when shutdown may be desired. Thus, alternative methods are still being sought.

### BRIEF SUMMARY OF THE INVENTION

In environments where the ambient temperature may vary above and below the freezing point of water over time, it is beneficial to operate a fuel cell in one of two modes, namely a “summer” mode or a “winter” mode. The choice of mode depends on whether the cell is expected to be shut down and stored at above or below freezing temperatures. “Summer” mode would be chosen when the cell is expected to be shut down and stored at above freezing temperatures, while “winter” mode would be chosen when the cell is expected to be shut down and stored at below freezing temperatures. While the terms “summer” mode and “winter” mode suggest that the modes are likely to be employed in specific seasons, it is to be understood that herein, it is the actual temperature expected during shutdown and storage, and not the season, that is determinative of mode choice.

The difference between the modes relates to the hydration level in the fuel cell. In summer mode, the oxidant relative humidity within the cell is greater than 100% over some portion of the oxidant channel length during steady state operation. That is, at some load or loads in steady state operation, at least a portion of the cell is oversaturated. In winter mode, the relative humidity within the cell is less than 100% over essentially the entire oxidant channel length during steady state operation. That is, the cell is essentially undersaturated throughout. (The fuel cell generally comprises an oxidant reactant flow field channel with an inlet and an outlet. Herein, it is the span from the oxidant channel inlet to the channel outlet which defines this oxidant channel length.) In summer mode, since the cell is operated in an oversaturated condition, cell performance during normal operation can be maximized. In an automotive application, operating at maximum performance is particularly important on hot summer days in order to be able to reject the waste heat produced by the fuel cell through the vehicle radiator.

On the other hand, in winter mode, the cell is always operating undersaturated and is thus in a desirable state for shutdown at any time because the water content is already adequately low throughout. An advantage of winter mode operation is that the startup time from below freezing temperatures is less than it would be if operated in summer mode prior to shutdown. Another advantage of winter mode operation is that the operating conditions are suitable for quickly removing any water created within the cell during a startup from below freezing (it being typically more difficult to remove water when the stack is cold). There can be a small performance penalty associated with winter mode during normal operation. This is generally acceptable since, insofar as waste heat rejection is concerned, it is relatively easy to reject the waste heat at low ambient “winter” temperatures.

In a typical solid polymer electrolyte fuel cell, the ionic conductivity of the electrolyte (e.g., a perfluorosulfonic acid polymer) increases with hydration level and is for instance greater at 100% relative humidity than at less than 100% relative humidity. For improved performance during steady state operation in summer mode, the relative humidity within the cell is thus preferably greater than 100% over more than 50% of the oxidant channel length (that is, most of the cell is in an oversaturated condition). In winter mode, it is also preferred for performance reasons to operate at relatively higher hydration levels. Thus, during steady state operation in winter mode, the relative humidity within the cell is preferably greater than 60% over essentially the entire oxidant channel length. Typical membrane electrolytes would not be expected to have an acceptable ionic conductivity at a lower relative humidity than this. Most preferably, the relative humidity within the cell is greater than 80% over essentially the entire oxidant channel length during steady state operation in winter mode.

During transients in operation, the fuel cell may briefly make excursions out of the preferred relative humidity states without losing the benefits of the invention. Thus, the relative humidity within the cell can briefly exceed 100% over some portion of the oxidant channel length in winter mode operation during certain transients (e.g., when changes are made to the external load applied across the fuel cell or perhaps during startup).

The method can be readily implemented in a fuel cell comprising flow field channels for two reactants and a coolant in which the direction of flow for both reactants and the coolant is essentially the same. In a complete fuel cell system, a control system would be employed that is configured to operate the fuel cell according to the inventive method. The relative humidity within the cell can be determined by calculation, using a humidity profile model as described in more detail below.

### BRIEF DESCRIPTION OF THE DRAWINGS

FIG. 1 shows a schematic diagram of a solid polymer electrolyte fuel cell series stack.

FIG. 2 shows a design for an oxidant flow field plate made of a series of linear parallel channels. This design was used in the cell of Example 1.

FIGS. 3a, b, and c show the relative humidity versus oxidant channel length profiles for the cell in Example 1 operating in summer mode under 400, 240, and 2 A loads respectively.

FIGS. 4a, b, and c show the relative humidity versus oxidant channel length profiles for the cell in Example 1 operating in winter mode under 400, 240, and 2 A loads respectively.

FIGS. 5a, b, c, and d show the relative humidity versus oxidant channel length profiles for the cell in FIG. 4a when certain parameters are changed (i.e., the air stoichiometry, the air inlet RH, the temperature difference, and the air inlet pressure respectively).

FIG. 6 shows the startup times for the various stack tests carried out in Example 1.

FIG. 7 shows the design of the oxidant flow field plate of the cell in Example 2 having serpentine oxidant flow field channels.

FIG. 8 compares the relative humidity versus oxidant channel length profiles for the cells in Examples 1 and 2 when operating in the same winter mode conditions at a 400 A load.

### DETAILED DESCRIPTION OF THE INVENTION

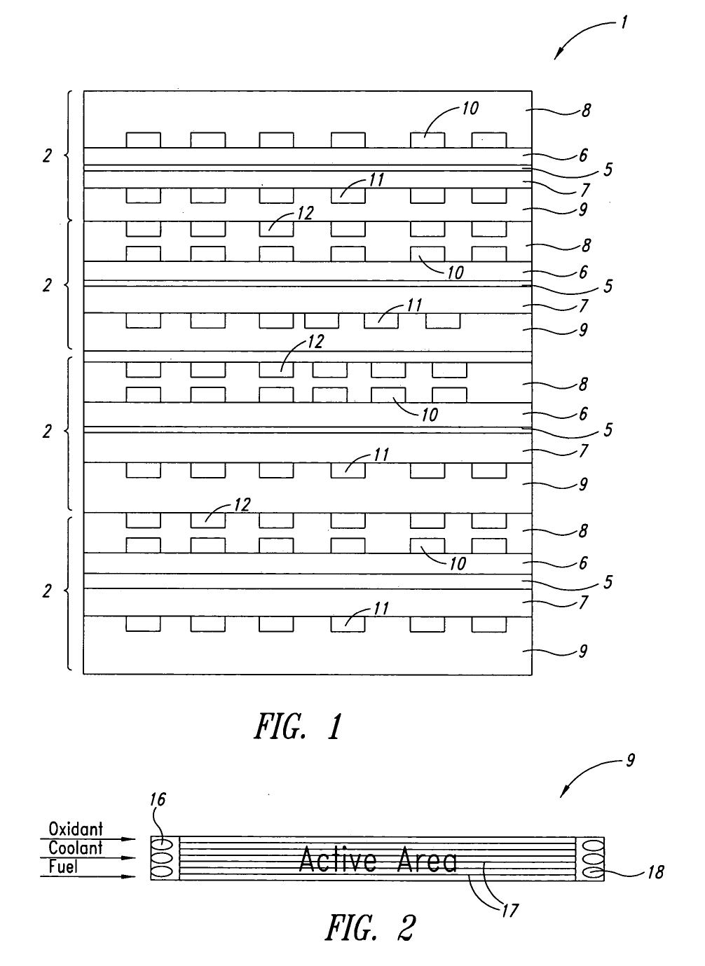

The inventive dual mode operation is particularly suited for use in solid polymer electrolyte fuel cell stacks. An exemplary such stack is shown schematically in a side cross-sectional view in FIG. 1. Stack 1 comprises a plurality of stacked cells 2. Each cell comprises a solid polymer electrolyte membrane 5. Suitable catalyst layers (not shown) serve as the anode and cathode in each cell and are applied to opposing faces of each membrane 5. Each cell also comprises an anode gas diffusion layer 6 and a cathode gas diffusion layer 7. And, adjacent the gas diffusion layers 6, 7 in each cell are a fuel (anode) flow field plate 8 and an oxidant (cathode) flow field plate 9. Each plate comprises fuel flow field channels 10 and oxidant flow field channels 11 respectively. As depicted, each fuel flow field plate 8 also contains coolant flow field channels 12. In this embodiment, channels 10, 11, and 12 are all linear, parallel, and run normal to the plane of the paper. Typically, negative and positive bus plates (not shown) and a pair of compression plates (not shown) are also provided at either end of the stack. Fluids are supplied to and from the reactant and coolant flow fields via various ports and manifolds (not shown).

FIG. 2 shows a top view of the oxidant flow field plate 9. Oxidant enters through inlet manifold opening 16, travels through oxidant channels 17, and exhausts out manifold opening 18. As shown, the direction of flow of the fuel, oxidant, and coolant are all the same, i.e., the flows are co-flow. In this co-flow design, reactant conversion and temperature increase monotonically along the length of the cell and thus the amount of water vapor that can be carried out in the gas flow increases too. Such a co-flow cell construction is desirable for use with the inventive method as it allows for a relatively simpler calculation of appropriate operating parameters and for a more uniform, and hence narrower, relative humidity versus length profile during winter mode operation (as illustrated in the Examples below).

The stack is then operated in one of two modes, either a summer mode for when the stack is expected to be shutdown above a freezing temperature or a winter mode for when the stack might be shutdown below a freezing temperature. In a preferred embodiment, the summer mode operating conditions are conventionally selected in order to obtain optimum stack performance during normal operation. Typically, this means the level of hydration in the stack is quite high with much of the cell being in an oversaturated condition.

For winter mode operation however, operating conditions are selected such that, in steady state operation, the cells in the stack are in an undersaturated condition throughout and thus the stack can be shutdown at any time without liquid water being present when shutdown begins. Preferably though, the relative humidity within the stack is still as high as possible without oversaturating any regions within the cells (i.e., dry regions in the cells are also to be avoided). Ideally therefore, the relative humidity (RH) within the cells is uniform and as close to 100% RH as practical without exceeding it.

A humidity profile model is provided below for calculating the relative humidity within the cell as a function of oxidant channel path length. Use of the model allows for a suitable set of operating parameters to be determined for a given cell construction. The operating parameters which can be varied in order to achieve winter mode conditions include: the coolant temperature and temperature gradient through the stack, and the reactant operating pressures, pressure drops, flow rates, humidification level, and stoichiometry.

Dual mode operation can be implemented in a fuel cell system by way of a suitable control sub-system. The control sub-system could be programmed to switch the operating parameters appropriately from summer to winter mode if a freezing event is anticipated. Freezing events may be expected and thus trigger the sub-system on the basis of date, geographic location, system temperature, and/or ambient air temperature.

An advantage of winter mode operation is that the startup time from below freezing temperatures can be significantly less than it would be if operated in summer mode prior to shutdown. (Winter mode reduces the formation of ice at the electrodes when shutdown and stored. The presence of such ice would hinder subsequent startup.) However, some trade-off in stack performance (power out) and lifetime may be expected in such winter mode operation. It is prudent then to use winter mode only when necessary and, again, to choose winter mode operating conditions that are still as wet as possible.

Humidity Profile Model

A model has been created to predict steady state hydration profiles for given fuel cell construction and operating conditions. It can thus be used to determine the relative humidity, RH, as a function of oxidant channel length in an operating fuel cell embodiment or alternatively to develop a preferred set of operating conditions to achieve a desired RH profile. Although the RH is less than 100% essentially throughout the stack at steady state in winter mode, the RH can be expected to exceed 100% during certain transients. For instance, when sudden changes are made to the external load applied across the fuel cell or when starting up the stack, the RH within the stack may briefly exceed 100%. This may be acceptable under some circumstances and the benefits of the invention may still be achieved. However, if the transients are too prolonged and/or involve too much of an increase in water content, it may be desirable to modify the operating conditions from those used at steady state during the transients. For instance, all the variable operating parameters except the stack outlet temperature might adjust fairly quickly to the desired “new” steady state conditions when a sudden large increase in load is experienced. If this resulted in an undesirable transient humidity profile, a possible solution would be to lower the coolant flow rate and increase the air stoichiometry during the load transient instead of making an immediate change to the desired steady state value. Those of ordinary skill may be expected to make modifications as needed for their specific circumstances. A further consideration arises when a stack is not operated sufficiently long after a freeze start to establish the desired steady state winter mode humidity conditions. A discussion is also provided below regarding dry-out time which provides guidance in dealing with this issue.

In the following, a solid polymer electrolyte fuel cell having straight oxidant (air), fuel (hydrogen), and coolant (antifreeze solution) flow field channels is assumed. The three fluids are designed to be co-flow (i.e., flows are parallel and in same direction). However, the model can be readily modified by those skilled in the art in order to derive equivalent equations for other embodiments (e.g., in which certain fluids flow in the opposite or counter flow direction, or in which certain fluids flow in a serpentine manner). Because the hydration state in the electrolyte and cell is dominated by conditions at the cathode, the relative humidity at the cathode was considered to be representative of the cell/electrolyte. The model assumes no significant interaction or exchange of water from the anode fuel stream through the electrolyte to the cathode oxidant stream, or conversely, exchange of water from the cathode to anode stream. (Those skilled in the art can appreciate that the use of anode recycle to increase the hydrogen stoichiometry is an effective means of humidifying the anode feed stream and controlling the relative humidity along the length of the anode flow field. The relative humidity on the anode side of the cell can be controlled to minimize any interaction or transfer of water vapor between the two reactant streams. Using the strategy as practiced on the cathode side of the cell, the anode stoichiometry is generally increased at lower power levels and smaller temperature differences between the cell inlet and outlet to control the relative humidity along the length of the cell.) Thus, the parameters that affect relative humidity and that were considered in the model were dry oxygen gas flow, water flow at the cathode side, cell temperature, and oxidant pressure. For calculation purposes, the cell is split into several discrete segments along its oxidant channel length, and the relevant parameters are determined for each segment. Using this technique, the relative humidity at each point along the oxidant channel length can be calculated. In the Examples that follow, the cell was split into one hundred segments and calculations were carried out using Excel software.

Oxygen Flow

The dry oxygen gas flow into the fuel cell is given by n_{g,inlet}. Oxygen is consumed along the length of the cell as a result of the electrochemical reactions taking place. It is given by the following equation (units in moles per second):

$${n}_{g , inlet} = \frac{I}{4 F} \cdot \frac{λ}{\% {O}_{2}} \qquad ( 1 )$$

where I is load current in Amperes, λ is air stoichiometry (i.e., the ratio of amount of air supplied at the oxidant inlet to that consumed electrochemically in the cell), F is Faraday's constant or 96485 C/mol, %O₂ is the concentration of oxygen in the oxidant (air in this case), and the constant 4 represents the two electrons that are transferred for each molecule of hydrogen in the following anode and cathode half reactions, 2H₂→4H⁺+4e⁻ and 4H⁺+4e⁻+O₂→2H₂O respectively. In the following overall stoichiometric fuel cell reaction, exactly two moles of hydrogen are provided for each mole of oxygen:
2H₂+O₂→2H₂O (2)
The dry oxygen gas flow at segment m along the cell, n_{g,m}, is given by the dry oxygen gas flow from the previous segment, n_{g,m-1}, minus the amount of oxygen consumed (units again in moles per second):

$${n}_{g , m} = {n}_{g , m - 1} - \frac{I \cdot \% load}{4 F} \qquad ( 3 )$$

where %load is the fraction of electrical load produced at a given segment. Because uniform load production is assumed, %load equals 1% for a calculation involving 100 segments. The inlet condition n_{g,0} used when calculating the dry oxygen gas flow for the first segment is simply that provided at the oxidant inlet of the cell, n_{g,inlet}, as defined in Equation (1). As oxygen is consumed in the cell, the dry oxygen gas flow decreases along the oxidant channel length.
Water Flow

The water flow in the cathode flow field, nᵥ in moles per second, can be derived from the definition of relative humidity, RH, which is the ratio of the mole fraction of water vapor in the oxidant mixture, nᵥ, to the mole fraction of water vapor in a saturated mixture at the same temperature and pressure, nₛₐₜ. The vapor is considered to be an ideal gas (hence PV=nRT) so the following correlation can be made:

$$RH = \frac{{n}_{v}}{{n}_{sat}} = \frac{{P}_{v}}{{P}_{sat}} ⇒ \\ {P}_{v} = {P}_{sat} \cdot RH \qquad ( 4 )$$

where Pᵥ is the partial pressure of the water vapor in the oxidant stream and Pₛₐₜ is the saturation pressure of the vapor at the same temperature.

From partial pressure laws and substituting vapor partial pressure as defined above, the partial pressure of the dry oxidant gas, P_{g}, is given by:
P=Pᵥ+P_{g} [symbol]
P_{g}=P−Pᵥ=P−Pₛₐₜ·RH (5)
where P is the operating pressure of the air.

Finally, water flow can be derived using Dalton's law of partial pressures and the ideal gas law:

$$\frac{{n}_{v}}{{n}_{g}} = \frac{{P}_{v}}{{P}_{g}} ⇒ \\ {n}_{v} = {n}_{g} \cdot \frac{{P}_{v}}{{P}_{g}} = {n}_{g} \cdot \frac{( {P}_{sat} \cdot RH )}{( P - {P}_{sat} \cdot RH )} \qquad ( 6 )$$

Subsequently, water flow at the inlet of the unit cell, n_{v,inlet}, is given by the following equation (units again are moles per second):

$${n}_{v , inlet} = {n}_{g , inlet} \cdot \frac{( {P}_{sat , inlet} \cdot {RH}_{inlet} )}{( {P}_{inlet} - {P}_{sat , inlet} \cdot {RH}_{inlet} )} \qquad ( 7 )$$

The water flow at segment m along the unit cell, n_{v,m}, is the sum of the water flow from the previous segment, n_{v,m-1}, plus the water produced in segment m:

$${n}_{v , m} = {n}_{v , m - 1} + \frac{I \cdot \% load}{2 F} \qquad ( 8 )$$

where the constant 2 represents the two electrons transferred for each molecule of water produced. The inlet condition n_{v,0} used when calculating the water flow for the first segment is simply the water flow at the inlet of the unit cell, n_{v,inlet}, as defined in Equation (7) above. As the air and hydrogen reactants are consumed electrochemically, water is produced, and thus the amount of water flow increases along the oxidant channel length.
Temperature

The temperature, T, typically rises with length along the cell because of the heat created from the exothermic reaction between the hydrogen and oxygen reactants. This heat warms up the supplied reactant and coolant fluids and evaporates water. In the model, the temperature is assumed to change linearly between the measured inlet and outlet temperatures of the cell. dT is defined to be the difference between the inlet and outlet temperature of the coolant.

Oxidant Pressure

The oxidant (air) pressure drop in the cathode flow field is assumed to increase linearly as the air passes through the flow field channels (units are bar). Thus:
P=(Pᵢₙₗₑₜ−x·P_{d}) (9)
where Pᵢₙₗₑₜ is the air pressure at the oxidant inlet, x is the fraction of the distance along the length of the cell, and P_{d} is the pressure drop along the entire cell. The pressure along the cell decreases as it is subjected to more pressure drop.
Relative Humidity Versus Oxidant Channel Length

Relative humidity, RH, can now be expressed in terms of the operating parameters defined above. It can be defined as:

$$RH = \frac{{P}_{v}}{{P}_{sat}} \qquad ( 10 )$$

Partial pressure laws state that the vapor partial pressure can be expressed as:

$$\frac{{P}_{v}}{P} = \frac{{n}_{v}}{n} ⇒ \\ {P}_{v} = \frac{{n}_{v}}{n} \cdot P = ( \frac{{n}_{v}}{{n}_{v} + {n}_{g}} ) \cdot P \qquad ( 11 )$$

Equation (11) is substituted into Equation

$$RH = \frac{{P}_{v}}{{P}_{sat}} , \qquad ( 10 )$$

where pressure, P, is given by Equation (9). This gives an expression for relative humidity as a function of x and the operating parameters defined above:

$$RH = ( \frac{{n}_{v}}{{n}_{v} + {n}_{g}} ) \frac{( {P}_{inlet} - x \cdot {P}_{d} )}{{P}_{sat}} \qquad ( 12 )$$

Water vapor saturation pressure, Pₛₐₜ, is temperature dependent. It is calculated using the empirical equation (equivalent to Standard steam tables; units are bar):
logPₛₐₜ=−2.1794+0.02953T−9.1837×10⁻⁵T²+1.4454×10⁻⁷T³ (13)

Profiles of relative humidity versus length can now be calculated using these latter two equations (12) and (13).

Dry-Out Time

Winter mode operation allows for the fuel cell to be shutdown in an acceptable sub-saturated state. However, during subsequent startup from below freezing temperatures, liquid water and ice generally can be produced because the fuel cell is cold. This water can fill pores in the cell components and hydrate the electrolyte to the point of saturation. In such a case, it is desirable to operate the cell for a sufficient time afterwards to dry it out and re-establish the desired winter mode sub-saturated state prior to shutting down again. Herein, the time it takes to re-establish winter mode conditions from a completely saturated cell, at a specified steady state load, is referred to as the dry-out time. The fuel cell is therefore preferably operated at least for the dry-out time before it is shutdown again. Clearly shorter dry-out times are preferred in applications that may otherwise only require brief periods of operation (e.g., short trips in an automobile).

Dry-out is accomplished by carrying water out as vapor in the outlet gas. The dry-out time, t_{dry}, is given by (in minutes):

$${t}_{dry} = \frac{{V}_{water} \cdot 1 g \text{/} {cm}^{3}}{{W}_{drying} \cdot 60 sec \text{/} min \cdot 18 g \text{/} mol} \qquad ( 14 )$$

where V_{water} is the water content to be removed in cubic centimetres, W_{drying} is the drying power of the air, 18 g/mol is the molecular weight of water, and the other constants are conversion factors. W_{drying} is the molar flow of liquid water being removed at the outlet. This is calculated as the molar flow of saturated water vapor at the outlet minus the total water molar flow at the outlet (units are moles per second):
W_{drying}=n_{sat,outlet}−n_{v,outlet} (15)

Water flow was defined in Equation (6) as:

$${n}_{sat , outlet} = {n}_{g , outlet} \cdot \frac{( {P}_{sat , outlet} )}{( ( {P}_{inlet} - {P}_{d} ) - {P}_{sat , outlet} )} \qquad ( 6 )$$

Since nₛₐₜ is defined as nᵥ at 100% relative humidity, the saturated water vapor at the outlet is given by the following equation:

$${n}_{sat , outlet} = {n}_{g , outlet} \cdot \frac{( {P}_{sat , outlet} )}{( ( {P}_{inlet} - {P}_{d} ) - {P}_{sat , outlet} )} \qquad ( 16 )$$

Water flow at the outlet is defined as the water flow entering the cell plus the amount of water produced:

$${n}_{v , outlet} = {n}_{v , inlet} + \frac{1}{2 F} \qquad ( 17 )$$

From a saturated state, the amount of liquid water to be removed V_{water} is constant for a given cell construction. Using the above equations, dry-out times can now be calculated for a given set of operating conditions.

The following examples employ the preceding model and are provided to illustrate certain aspects and embodiments of the invention but should not be construed as limiting in any way.

### EXAMPLE 1

In the following, the fuel cell being considered was a solid polymer electrolyte fuel cell designed for use in an 100 kW automobile engine stack. The flow field plate design was similar to that shown in FIG. 2 in which both fuel (hydrogen) and oxidant (air) reactants as well as coolant (antifreeze solution) were distributed via a series of straight, parallel flow channels and in which both reactant flows and coolant flow were co-flow.

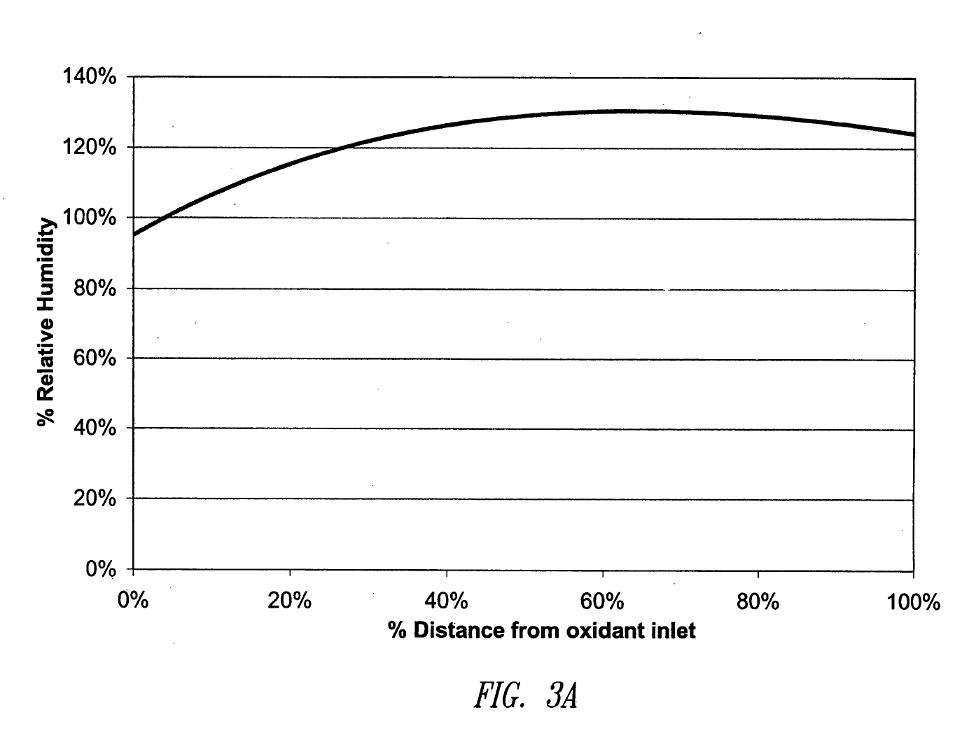

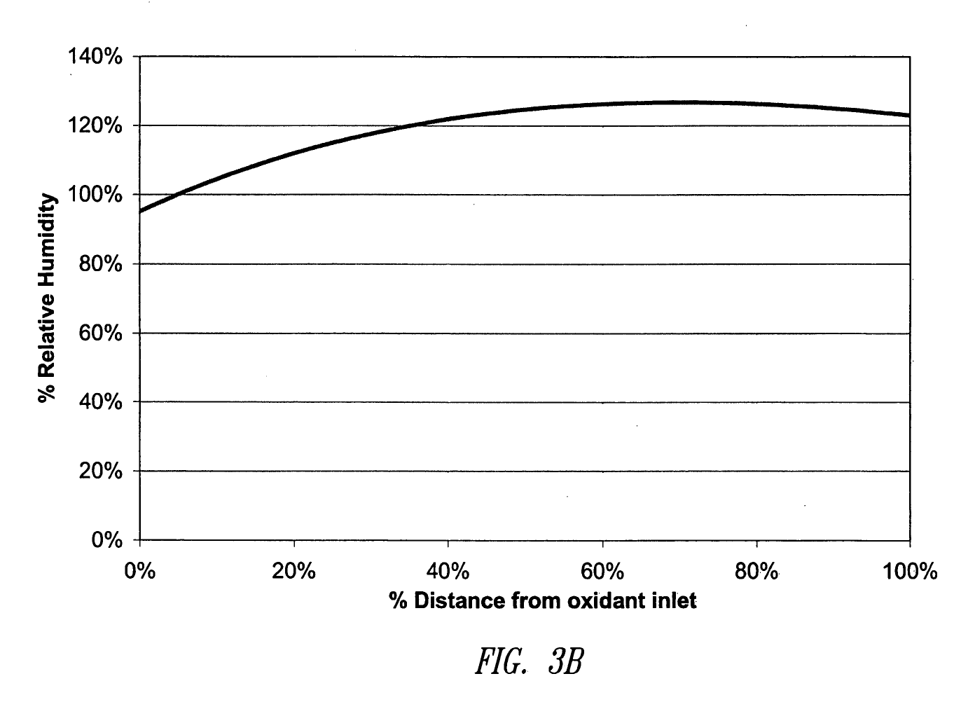

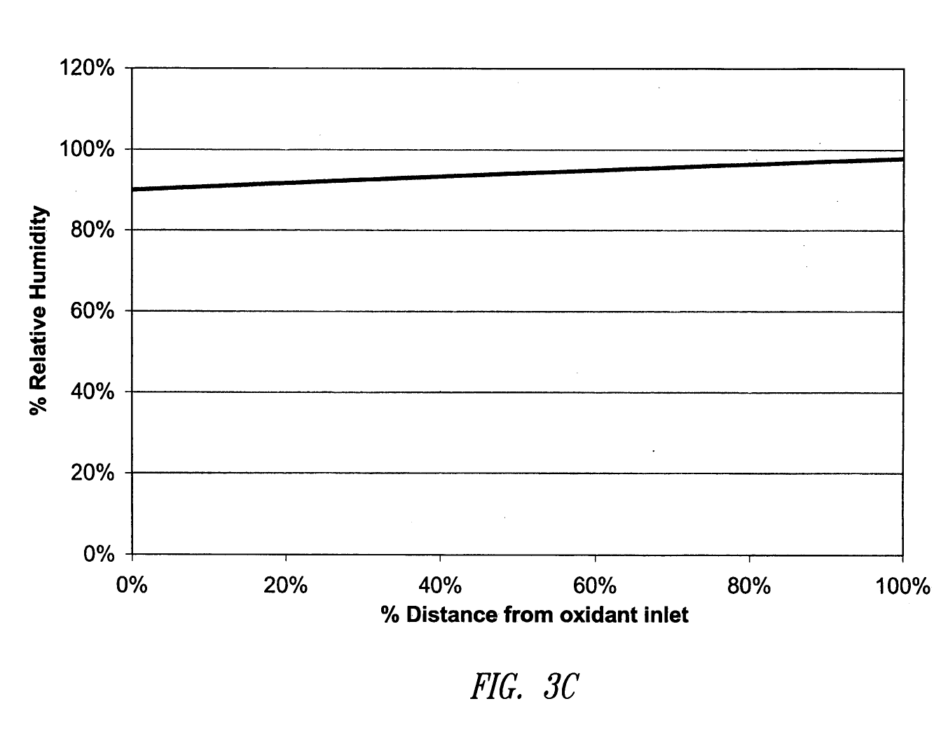

For optimum performance of this fuel cell during normal operation, the set of operating parameters shown in Table 1 was used. Note that different values were employed for different electrical loads. Table 1 lists values for three illustrative load points (maximum load of 400 A, partial load of 240 A, and a minimum idle load of 2 A). The relative humidity versus oxidant channel length profiles for this cell at these three loads were calculated using the above model and are plotted in FIGS. 3a, 3b, and 3c (for 400 A, 240 A and 2 A loads respectively). These operating parameters are suitable for summer mode operation. However, most of the cell operates in an oversaturated condition at partial or full load. Thus, when below freezing temperatures might be encountered during storage, this fuel cell may desirably be operated in winter mode.

TABLE 1
Operating conditions for summer mode

| | | | |
|---|---|---|---|
| Load (A) | 2 | 240 | 400 |
| Air stoichiometry | 13 | 1.8 | 1.8 |
| Air inlet RH (%) | 90% | 95% | 95% |
| Air inlet pressure (bar) | 1.05 | 1.69 | 2.0 |
| Air pressure drop | 50 | 500 | 600 |
| (mbar) | | | |
| Coolant inlet | 60 | 60 | 60 |
| temperature (° C.) | | | |
| Average temperature | 0 | 7.5 | 10 |
| difference, dT (° C. ± 1) | | | |

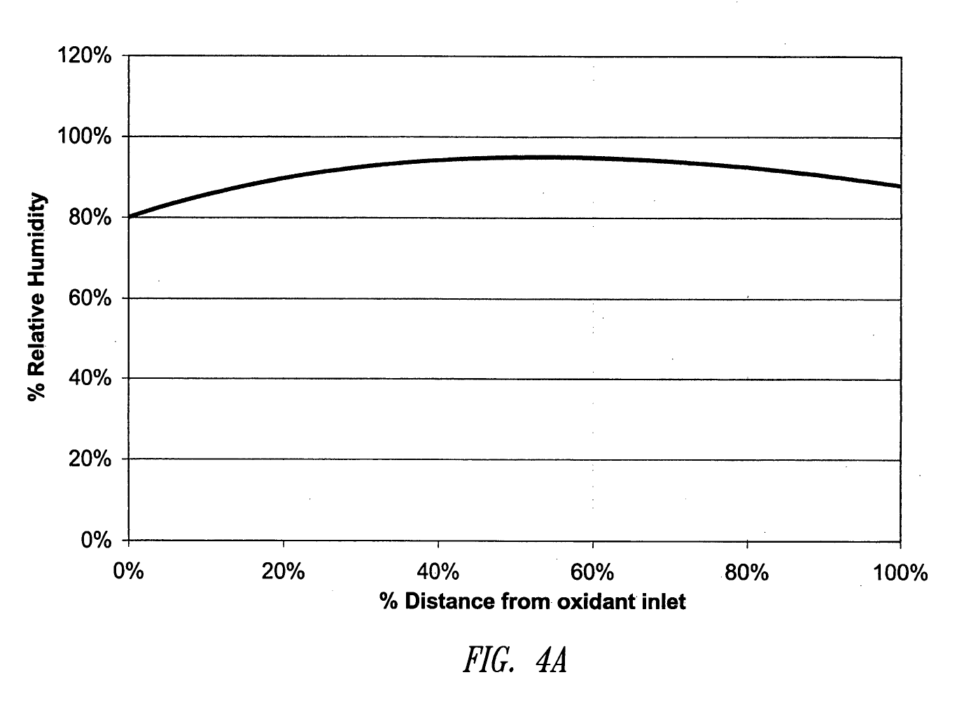

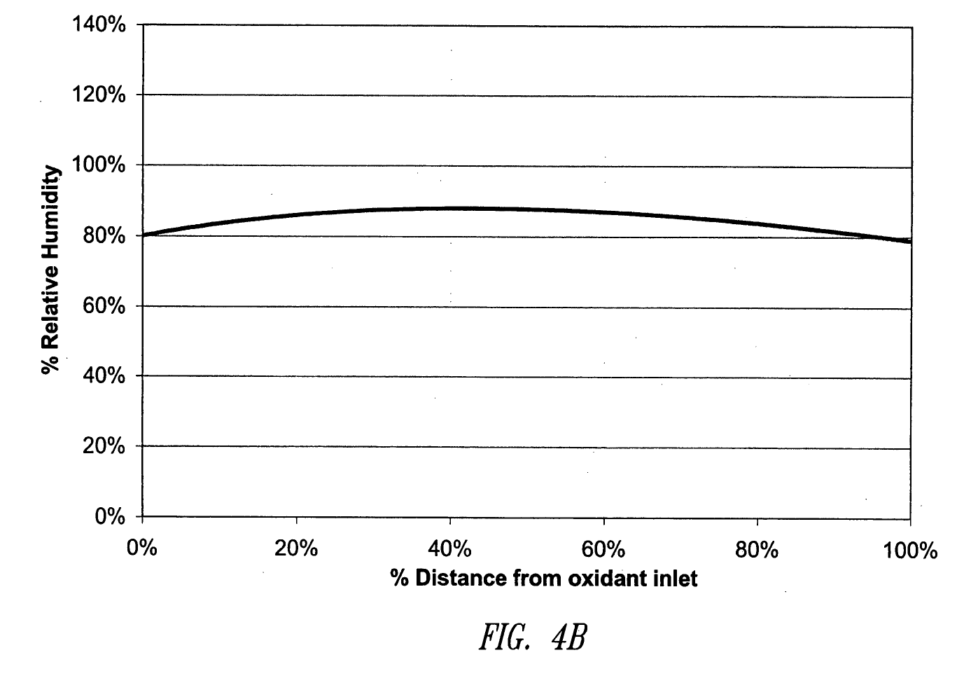

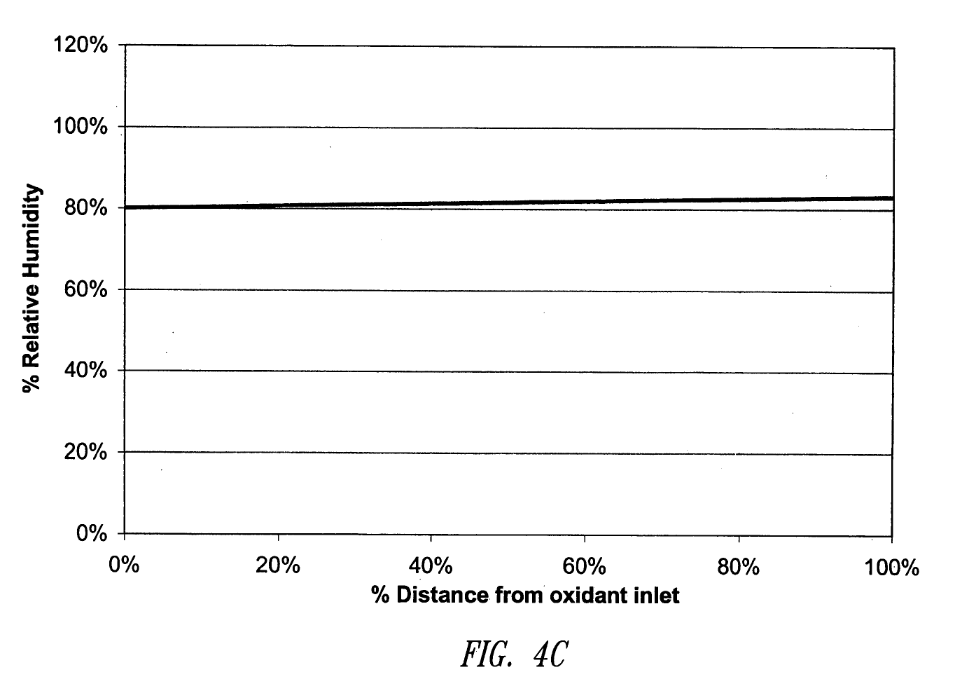

For the same cell, Table 2 shows a possible set of operating parameters suitable for winter mode use. Again, values are listed for the same three load points. The relative humidity versus length profiles were recalculated for this winter mode operation and are plotted for comparison purposes in FIGS. 4a, 4b, and 4c. As is evident in these Figures, the relative humidity over the entire oxidant channel length and at all loads is less than 100% but greater than about 80%. This set of parameters thus allows for shutdown in a sub-saturated state throughout while still providing substantial humidification throughout in order to maintain preferred cell performance and longevity. Also shown in Table 2 though are the calculated dry-out times. (The water content is determined by measuring the total amount of water stored in the MEA and plates when in a saturated state. In this case, there was approximately 4.5 mg/cm² of water in the MEA and 2.5 mg/cm² in the plate.) Note that the dry-out time at low load (i.e., 2 A) is quite substantial (about 80 minutes). This might not be considered acceptable for some applications (e.g., where, after starting up from freezing, the cell might not be operated at a high enough load for long enough prior to shutting down again to re-establish the relative humidity profiles of FIG. 4).

TABLE 2
Operating conditions for winter mode

| | | | |
|---|---|---|---|
| Load (A) | 2 | 240 | 400 |
| Air stoichiometry | 13 | 1.8 | 1.8 |
| Air inlet RH (%) | 80% | 80% | 80% |
| Air inlet pressure (bar) | 1.05 | 1.69 | 2.0 |
| Air pressure drop* | 48 | 464 | 638 |
| (mbar) | | | |
| Coolant inlet | 70 | 70 | 70 |
| temperature (° C.) | | | |
| Average temperature | 0 | 10 | 10 |
| difference, dT (° C. ± 1) | | | |
| Dry-out time (min) | 80.2 | 3.2 | 3.0 |

*Air pressure drop calculated based on 600 mbar at 400 A in summer mode and then scaled according to volumetric flow rate (including vapor)

The dry-out time problem may then be addressed using a different set of operating parameters in winter mode that provide greater drying conditions. Table 3 for instance shows such an alternative set of operating parameters which provide for much reduced dry-out times (e.g., the dry-out time is now less than 5 minutes at 2 A load). The trade-off in this case however is that cell performance and longevity would be expected to be somewhat worse. Thus, it may be preferable to employ these parameters only for a brief period before an anticipated shutdown.

TABLE 3
Alternative operating conditions for winter mode

| | | | |
|---|---|---|---|
| Load (A) | 2 | 240 | 400 |
| Air stoichiometry | 72 | 1.8 | 1.8 |
| Air inlet RH (%) | 50% | 80% | 80% |
| Air inlet pressure (bar) | 1.2 | 1.69 | 2.0 |
| Air pressure drop* | 201 | 464 | 638 |
| (mbar) | | | |
| Coolant inlet | 70 | 70 | 70 |
| temperature (° C.) | | | |
| Average temperature | 0 | 10 | 10 |
| difference, dT (° C. ± 1) | | | |
| Dry-out time (min) | 4.9 | 3.2 | 3.0 |

*Air pressure drop calculated based on 600 mbar at 400 A in summer mode and then scaled according to volumetric flow rate (including vapor)

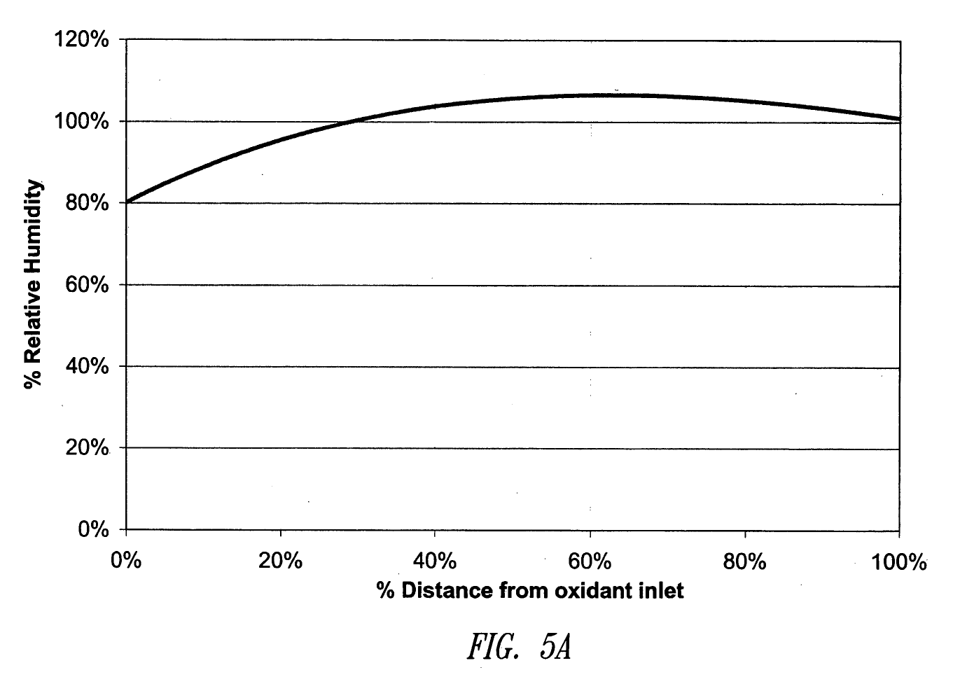

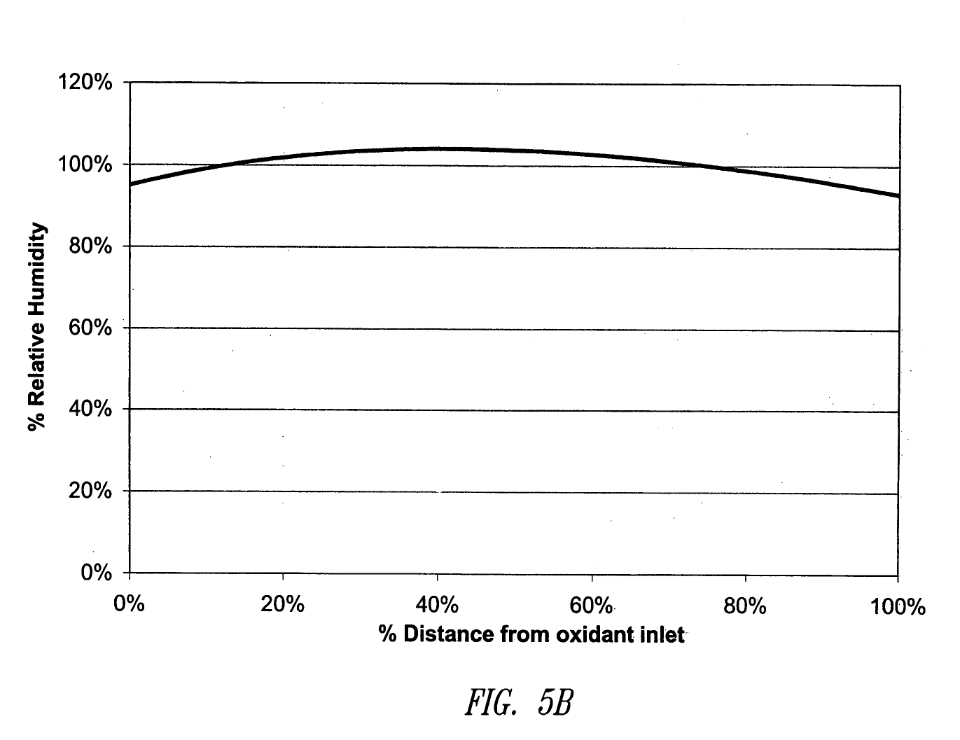

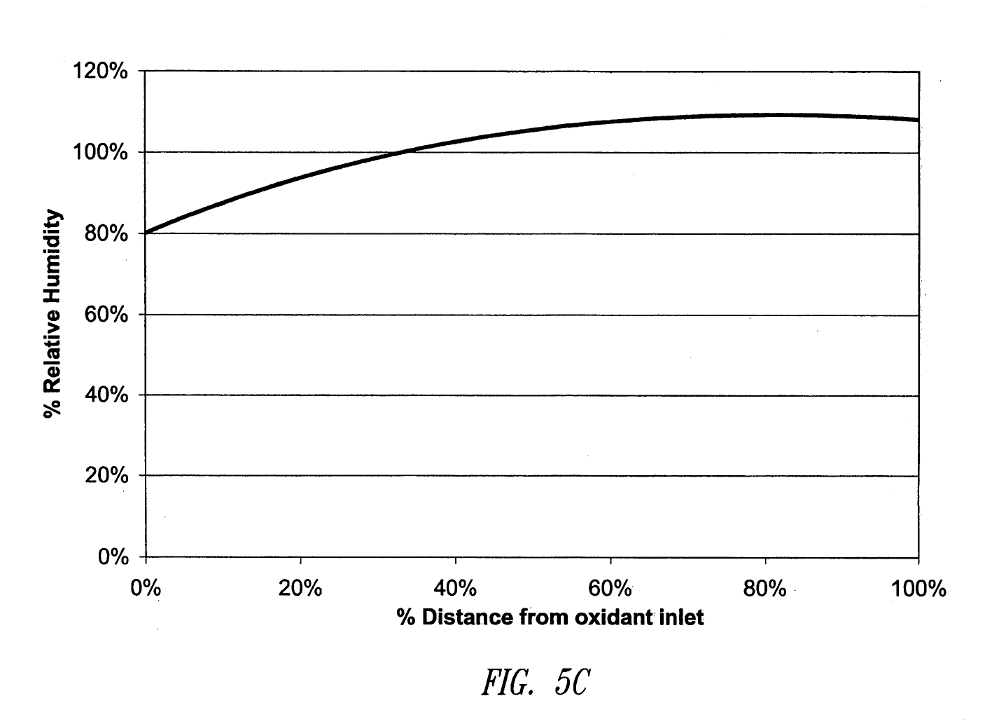

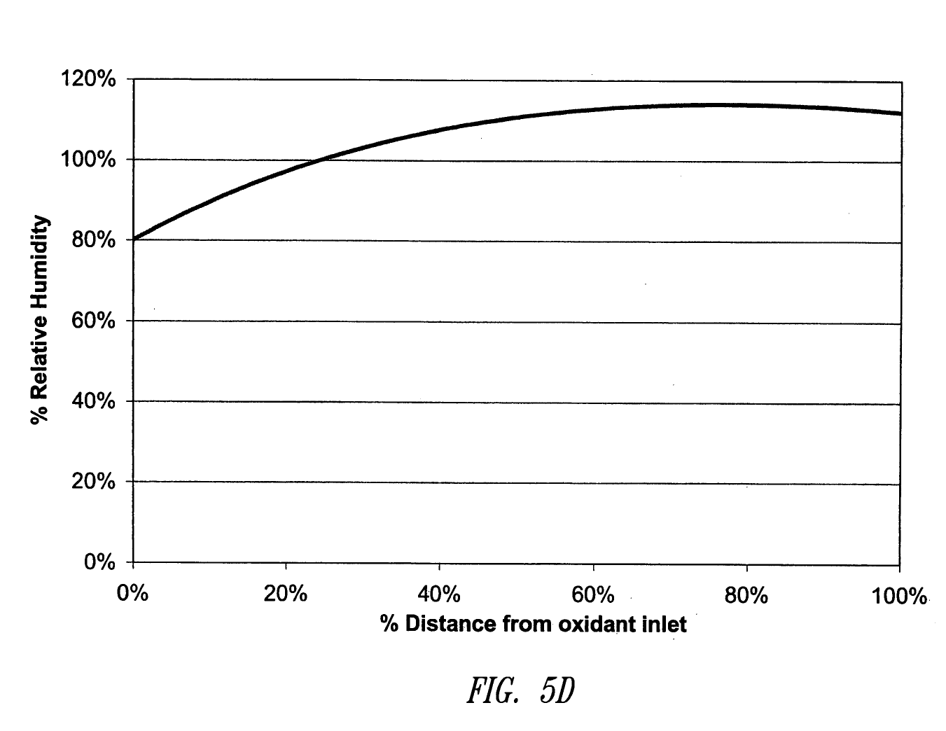

This Example illustrates how the typical operating parameters of an automotive fuel cell stack (e.g., those of Table 1) might be altered to achieve suitable relative humidity profiles for winter mode operation (e.g., those of Tables 2 or 3). To further illustrate the effect that varying the operating parameters can have on the humidity profile, FIGS. 5a-d show the relative humidity versus length profiles at 400 A load when certain parameters are changed in winter mode operation. For instance, FIG. 5a shows the profile when the air stoichiometry is 1.4 instead. The air stoichiometry is decreased by decreasing the airflow which results in an increase in relative humidity. FIG. 5b shows the profile when the air inlet RH is 95% instead. Increasing the air inlet RH increases water flow along the cell and increases the relative humidity inside. FIG. 5c shows the profile when the temperature difference is 5° C. instead. Decreasing the temperature gradient across the cell increases the relative humidity also. Finally, FIG. 5d shows the profile when the air inlet pressure is 2.5 bar instead. Increasing the air inlet pressure increases the relative humidity in the cell.

To demonstrate the effect that winter mode operation has on startup times, a 20 cell series stack was used which was similar in construction to that considered earlier in this example. A series of startup tests was performed in which the stack was operated in either summer or winter mode conditions (similar to those in Tables 1 or 2 above), shutdown, stored until equilibrated at −15° C., and then started up again. The time taken during startup for the stack to deliver 30% of maximum power was determined.

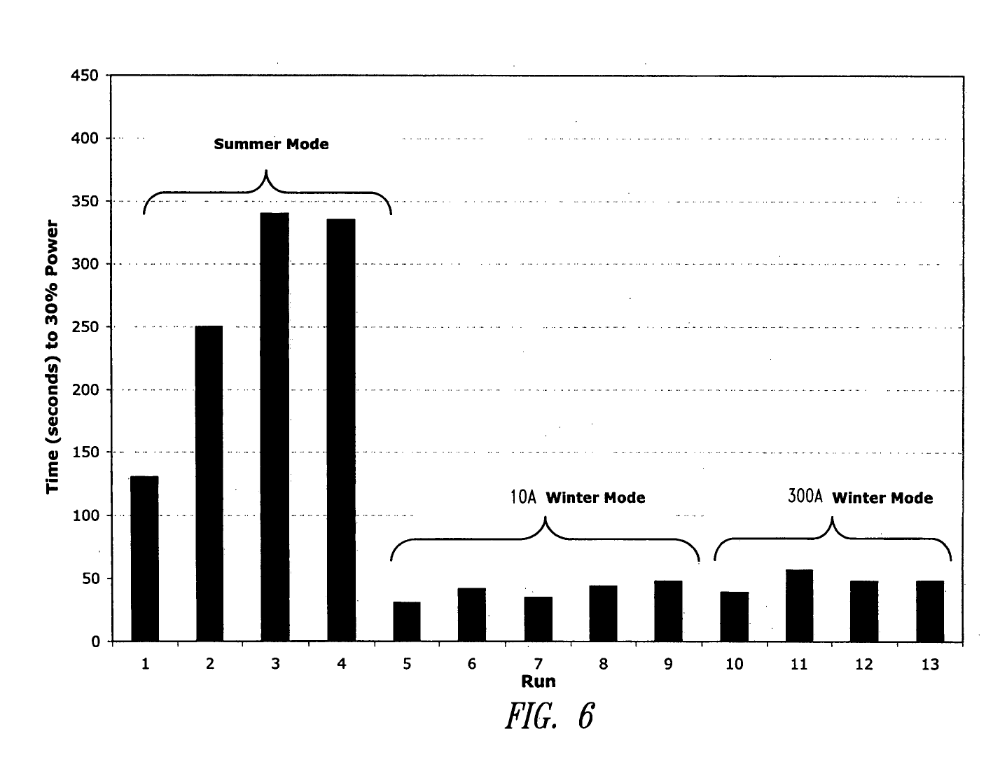

FIG. 6 shows the startup times for these various tests. The same conditions were used during startup in all case. Runs 1-4 show results when the stack was operated in summer mode prior to shutdown. Runs 5-9 show results when the stack was operated in winter mode at 10 A load just prior to shutdown. Finally, runs 10-13 show results when the stack was operated in winter mode at 300 A load just prior to shutdown. As is evident from this Figure, winter mode operation markedly improves startup time in this fuel cell stack.

### EXAMPLE 2

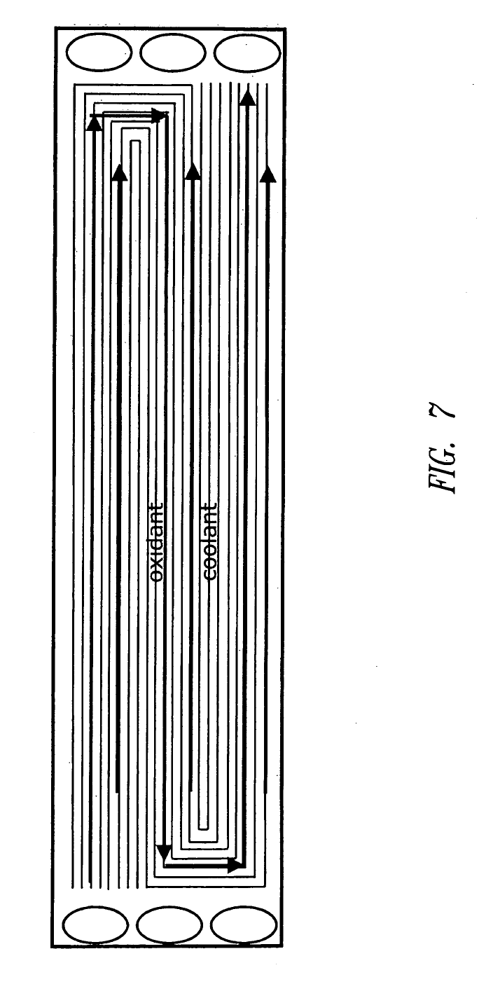

In this Example, a fuel cell with a serpentine oxidant reactant flow field undergoing the same winter mode operating conditions was modelled. Again, the fuel cell being considered was a solid polymer electrolyte fuel cell designed for use in an 100 kW automobile engine stack. However, this time the oxidant flow field design was that depicted in FIG. 7. The flow of oxidant in this Figure initially is from left to right (1st leg), then right to left (2nd leg), and finally left to right again (3rd leg). Coolant flow was linear however and always left to right. Thus, the oxidant and coolant flows are co-flow in the 1 st and 3rd legs and counter flow in the 2nd leg.

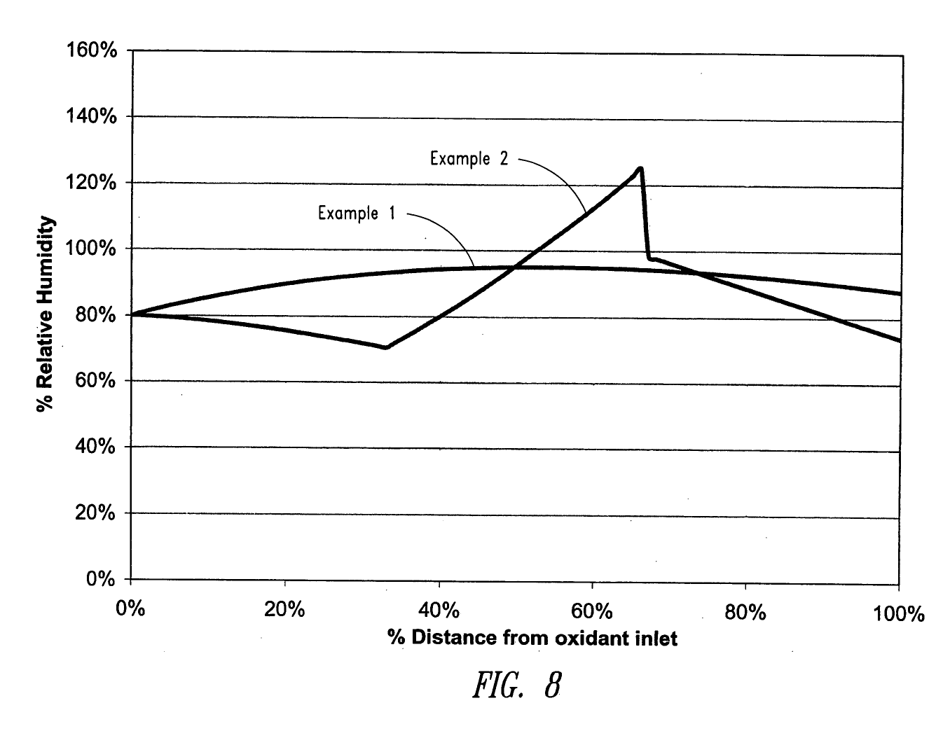

The relative humidity versus length profile for this cell can also be calculated using the model above. However, the temperature gradient goes in the opposite direction for the 2nd leg as compared to the 1st and 3rd legs. The temperature versus oxidant channel length profile thus has a zigzag shape and so does the relative humidity versus oxidant channel length. FIG. 8 shows the RH versus profile for this cell and compares it to that of Example 1 under a 400 A load. Although the average water content in the Example 2 cell is lower than that of Example 1 under the same operating conditions, the serpentine design is unfavourable in that there are locations in the cell that are undesirably dry (e.g., at about 30% of oxidant channel length) and undesirably wet (e.g., at about 65% of oxidant channel length). The latter situation can result in ice blockages in the channel and MEA if stored below freezing. In order to obtain sub-saturated conditions throughout, even drier operating conditions must be used for winter mode operation for this cell.

(Note that the model for calculating the time to dry out the cell is not applicable here because the calculations are based on an assumption that the relative humidity profile is fairly uniform and subsaturated. In this case, the inlet and outlet oxidant relative humidity do not represent boundary conditions for the relative humidity in the middle of the cell.)

Although cells with such serpentine flow field designs can be operated in a winter mode, this example shows the advantage of employing fuel cell constructions in which the reactant and coolant flow configurations are co-flow. A more uniform humidity profile can be achieved, thus allowing for the desired sub-saturated condition without any undesirably dry regions within.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A method of operating a fuel cell in an environment whose temperature may vary above and below the freezing point of water over time, the fuel cell comprising an oxidant reactant flow field channel having an inlet and an outlet and an oxidant channel length defined by the span from the oxidant channel inlet to the channel outlet, the method comprising:
operating the cell in a summer mode when the cell is expected to be shut down and stored at above freezing temperatures; and
operating the cell in a winter mode when the cell is expected to be shut down and stored at below freezing temperatures;
wherein the relative humidity within the cell is greater than 100% over some portion of the oxidant channel length during steady state operation in summer mode and the relative humidity within the cell is less than 100% over essentially the entire oxidant channel length during steady state operation in winter mode.

2. The method of claim 1 wherein the relative humidity within the cell is greater than 100% over more than 50% of the oxidant channel length during steady state operation in summer mode.

3. The method of claim 1 wherein the relative humidity within the cell is greater than 60% over essentially the entire oxidant channel length during steady state operation in winter mode.

4. The method of claim 3 wherein the relative humidity within the cell is greater than 80% over essentially the entire oxidant channel length during steady state operation in winter mode.

5. The method of claim 1 wherein the fuel cell is a solid polymer electrolyte fuel cell.

6. The method of claim 5 wherein the solid polymer electrolyte is a perfluorosulfonic acid polymer.

7. The method of claim 5 wherein the ionic conductivity of the solid polymer electrolyte is greater at 100% relative humidity than at less than 100% relative humidity.

8. The method of claim 5 wherein the fuel cell is a fuel cell stack comprising a plurality of cells stacked in series.

9. The method of claim 1 wherein relative humidity is determined by calculation using a humidity profile model.

10. The method of claim 1 wherein the relative humidity within the cell exceeds 100% over some portion of the oxidant channel length in winter mode operation during transients arising from changes to the external load applied across the fuel cell.

11. The method of claim 1 wherein the relative humidity within the cell exceeds 100% over some portion of the oxidant channel length in winter mode operation during transients arising from start up.

12. The method of claim 1 wherein the fuel cell comprises flow field channels for two reactants and a coolant and wherein the direction of flow for both reactants and the coolant is essentially the same.

13. The method of claim 1 wherein the startup time from below freezing temperatures is less than it would be if operated such that the relative humidity within the cell was greater than 100% over some portion of the oxidant channel length during steady state operation prior to shutdown.

14. A fuel cell system comprising a fuel cell and a control system, the fuel cell comprising a reactant flow field channel having an inlet and an outlet and wherein the channel length is defined by the span from the channel inlet to the channel outlet, wherein the control system is configured to operate the fuel cell according to the method of claim 1.
